(19) United States
(12) Patent Application Publication
(10) Pub. No.: US 2016/0308696 A1
(43) Pub. Date: Oct. 20, 2016

(54) PACKET RELAY DEVICE, AND COPY FUNCTION DISTRIBUTION METHOD OF PACKET RELAY DEVICE

(71) Applicant: FUJITSU LIMITED, Kawasaki-shi (JP)

(72) Inventor: Kazuto NISHIMURA, Yokohama (JP)

(73) Assignee: FUJITSU LIMITED, Kawasaki-shi (JP)

(21) Appl. No.: 15/064,953

(22) Filed: Mar. 9, 2016

(30) Foreign Application Priority Data
Apr. 20, 2015 (JP) 2015-086321

(51) Int. Cl. H04L 25/20; H04L 12/721

(52) U.S. Cl. CPC H04L 25/20; H04L 45/32; H04L 45/38

(57) ABSTRACT

An apparatus includes a plurality of first circuits that duplicate and transmit a packet, a memory that store the packet correspond to one of the plurality of first circuit, and a second circuit that select one of the plurality of first circuits, using cumulative remaining copy amount correspond to each of the plurality of first circuits that are calculated based on the packet accumulation in the memory.

### CROSS-REFERENCE TO RELATED APPLICATION

This application is based upon and claims the benefit of priority of the prior Japanese Patent Application No. 2015-086321, filed on Apr. 20, 2015, the entire contents of which are incorporated herein by reference.

### FIELD

The embodiments discussed herein are related to a packet relay device, and a copy distribution method of the packet relay device.

### BACKGROUND

A packet copy function that is a technique for duplicating a packet in order to transmit a single input packet to a plurality of output links is known as one of the functions of a packet relay device.

A copy functional block of a packet relay device in the related art is used, for example, when multicasting (flooding) an unlearned packet of which a destination is not known.

FIG. 24 illustrates an example of a packet relay device 8 having a copy function. The packet relay device 8 in FIG. 24 duplicates a packet that has been sent from a transmission source 580 by a copy functional block 500 of the packet relay device 8, and sends the copy packets to transmission destinations 590a to 590c. The copy functional block 500 duplicates and sends the packets of a desired number stored in a storage unit 512 in a copy unit 510 depending on the flow by referring to a copy table 511.

For example, in the case of FIG. 24, the copy table 511 represents that the packet of multicast flow #1 is to be output to the transmission destinations 590a and 590b, and thus the number of times of duplicating is two.

The packet copy function is a process having a great amount of load, among processes of the packet relay device 8. That is because the number of copies of a packet also increases, as the number of destinations increases.

Therefore, as a copy distribution technique of the packet relay device in the related art, Japanese Laid-open Patent Publication No. 2011-15321 is suggested.

### SUMMARY

According to an aspect of the invention, an apparatus includes a plurality of first circuits, a memory, and a second circuit. The plurality of first circuits configured to duplicate and transmit a packet. The memory configured to store the packet corresponds to one of the plurality of first circuit. The second circuit configured to select one of the plurality of first circuits, using cumulative remaining copy amount correspond to each of the plurality of first circuits that are calculated based on the packet accumulation in the memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a functional configuration example of a typical packet relay device;

FIG. 2 is a diagram illustrating a functional configuration example of an interface card in the packet relay device;

FIG. 3 is a diagram illustrating a general processing flow example of the packet relay device;

FIG. 4 is a diagram illustrating a configuration example of a copy functional block according to Embodiment 1;

FIGS. 5A and 5B are diagrams illustrating a time interval in duplicating of a packet;

FIGS. 6A and 6B are diagrams illustrating an example in which an order reversal occurs at the time of using a plurality of copy units;

FIGS. 7A and 7B are diagrams illustrating a relationship between an apparent queue length and a substantial queue length in a copy function;

FIGS. 8A and 8B are diagrams illustrating an example of a concept of the embodiments when using a plurality of copy units;

FIG. 9 is a diagram illustrating an example of performing load distribution, using the concepts of the present embodiment when packets in the same flow are continuous;

FIG. 10 is a diagram illustrating an example of a flowchart of a load distribution unit;

FIG. 11 is a diagram illustrating an example of a flowchart of the copy unit;

FIG. 12 is a diagram illustrating a packet relay device 5 of a modification example using the copy functional block of the embodiment;

FIG. 13 is a diagram illustrating a configuration example of a copy functional block according to Embodiment 2;

FIGS. 14A to 14C are diagrams illustrating an example in which order reversal occurs when a queue length is different for each packet;

FIG. 15 is a diagram illustrating an example of a flowchart of a load distribution unit;

FIG. 16 is a diagram illustrating an example of a flowchart of a copy unit;

FIG. 17 is a diagram illustrating a configuration example of a copy functional block according to Embodiment 3;

FIG. 18 is a diagram illustrating a configuration example of a copy functional block according to Embodiment 4;

FIG. 19 is a diagram illustrating an example of a flowchart illustrating a condition in reading of a composite unit in FIG. 18;

FIG. 20 is a diagram illustrating an example of a flowchart of a copy unit;

FIG. 21 is a diagram illustrating a configuration example of a copy functional block according to Embodiment 6;

FIGS. 22A and 22B are diagrams illustrating an example in which order reversal occurs in packets in the same flow when a copy unit is newly added;

FIG. 23 is a diagram illustrating an example in which a dummy packet is sent to a newly added copy unit using a dummy generation unit; and

FIG. 24 is a diagram illustrating a configuration example of a packet relay device having a copy function in the related art.

### DESCRIPTION OF EMBODIMENTS

In a copy method of a packet relay device disclosed in Japanese Laid-open Patent Publication No. 2011-15321, since a copy unit to be used for duplicating is determined from multiple copy units, based on the flow of a packet, it is possible to achieve an effect of efficiency of duplicating and a reduction in manufacturing cost in the packet relay device.

However, since distribution is performed simply based on the flow of a packet, if the number of processes for the packets in the same flow increases, deviation occurs in the number of processes, and there is a problem in that efficiency of duplicating is not improved. It is desired to distribute the processes for the packets in the same flow in order to perform efficient duplicating. When performing duplicating by distributing the packets in the same flow as equally as possible, there is a problem of the occurrence of order reversal of the packets in the same flow. This problem can be solved by giving sequence numbers to internal headers applied to the packets when receiving the packets, and performing sequence rearrangement when transmitting the packets, but there is a problem of an increase in the cost of production to add a unit for performing the order rearrangement, and a delay for performing the order rearrangement.

Hereinafter, preferred embodiments of a disclosed technique will be described in detail, with reference to the accompanying drawings.

### Embodiment 1

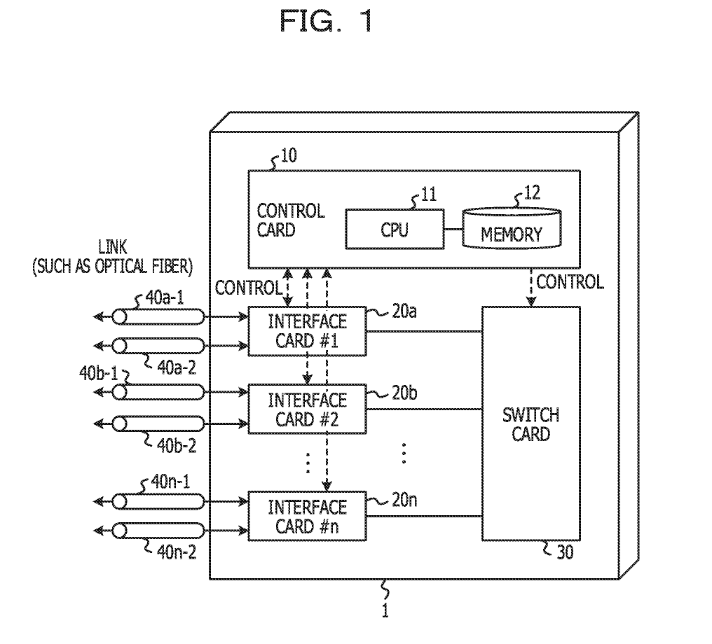

FIG. 1 is a diagram illustrating an overall configuration of a chassis-type packet relay device (router/switch and the like) 1. The packet relay device 1 includes interface cards 20a, 20b, . . . , and 20n, a switch card 30, a control card 10, and the like. Further, the interface cards 20a, 20b, . . . , and 20n are referred to as an interface card 20, when they are not distinguished.

The control card 10 includes a CPU 11 and a memory 12, and for example, the CPU 11 controls the respective interface cards 20 and the switch card 30, and stores the state of the device and the like, in the memory 12.

Further, links 40a-1, 40a-2, . . . , and 40n-2 made from optical fibers or the like are connected to the interface card 20, for input and output of the packet relay device 1. In addition, the links 40a-1, 40a-2, . . . , and 40n-2 are simply referred to as a link 40, when they are not distinguished. Two links 40 are connected to each interface card 20 in FIG. 1, but the number of links is not limited thereto.

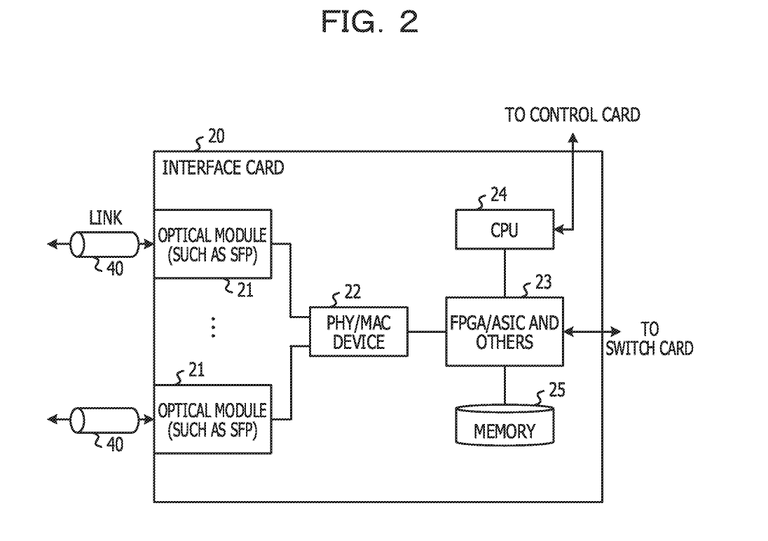

Further, FIG. 2 illustrates a configuration example of the interface card 20 of the packet relay device 1. Signals that are input to the interface card 20 from the link 40 are converted to electric signals by the optical module 21, and are sent to a PHY/MAC device 22 having a PHY/MAC processing function. For example, the optical module 21 uses a standard optical transceiver such as a small form factor pluggable (SFP).

The PHY/MAC device 22 performs an extraction process, and the like, on packets, and passes the packet to a FPGA/ASIC and others 23. The FPGA/ASIC and others 23 performs a traffic process and a process of transmitting or receiving packets to or from the switch card 30 for exchanging packets with another interface card 20. In addition, the interface card 20 has a packet data buffer and a setting table memory 25, for performing the traffic process. In addition, the interface card 20 includes a CPU 24 that is an interface for software processing and the control card 10.

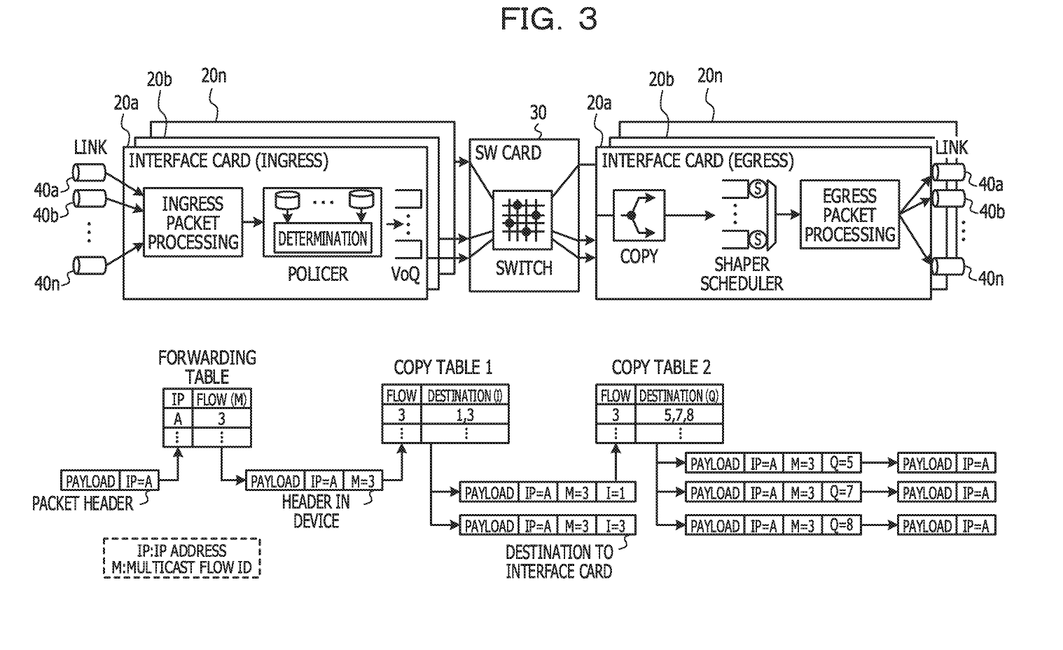

Here, FIG. 3 illustrates an example of a flow of a process including duplicate of a multicast packet by using a logical configuration diagram of the packet relay device 1 in FIG. 1. The interface card 20 in FIG. 3 is illustrated by being separated into an Ingress side and an Egress side. In addition, the interface card 20 has functions of both the Ingress side and the Egress side. In addition, the Ingress side and the Egress side may have separate (dedicated) interface cards 20. In this case, each interface card 20 performs any one of input and output.

The interface card 20 on the Ingress side is used for processes of input of a signal to transmit to the switch card 30. The interface card 20 on the Egress side is used for processes of transmission from the switch card (SW card) 30 to output from the interface card 20. Further, the interface card 20 can also be provided with functions of both the Ingress side and the Egress side so as to transmit and receive packets through a single link 40, as illustrated in FIG. 2, and the interface card 20 may be separate (exclusive) by securing the transmission direction of the link 40.

In the case of the chassis-type packet relay device 1, the copy of packets is often performed at two positions of the switch card 30 and the interface card 20 on Egress side. In the former case, copy is performed between interface cards 20, and in the latter case, copy is performed between ports in the interface card 20.

Further, the functions provided in the interface cards 20 on Ingress side and the Egress side in FIG. 3 are performed, for example, by the FPGA/ASIC and others 23 in FIG. 2. A table referred to by the interface card 20 and the like is stored in the memory 25 and the like.

If packets are input from the link 40 to the interface card 20, a packet process on Ingress side of the interface card 20 is performed. The packet process on the Ingress side acquires flow-information-in-device (M in FIG. 3) which is information on a packet process in the packet relay device 1, based on the header information, with reference to Forwarding Table. The flow information is information to be attached depending on the flow of the packet.

The flow-information-in-device is stored in a header-in-device which stores information treated in the packet relay device 1 for the packets. The packets obtaining flow-information-in-device are sent to the switch card 30. At this time, if there are inputs from a plurality of interface cards 20 on the Ingress sides, the switch card 30 may combine and process the inputs from the plurality of interface cards 20.

The switch card 30 duplicates packets of the number of destinations of the interface cards 20 on the Egress side from the flow-information-in-device (M) of a packet and a copy table 1, and assigns the destination information (I in FIG. 3) to the interface cards 20 on the Egress side, and distributes the packets to the interface cards 20 on the Egress side. The destination information (I in FIG. 3) on the interface cards 20 is stored in, for example, the header-in-device, and it becomes a state in which information (I) addressed to the interface card 20 and the flow information (M) are stored in the header-in-device.

The interface card 20 on the Egress side obtains destination information (corresponding to Q in FIG. 3) of the output port from information from the flow-information-in-device (M) of the packets that are sent from the switch card 30, and information in the copy table 2 in the interface card 20 on the Egress side, and copies the packets of the same number. The respective copy packets are transmitted to the respective output ports of the destination, based on address information (corresponding to Q in FIG. 3) on the corresponding output ports.

For example, if packets are input to the packet relay device 1, the interface card 20 obtains a multicast flow ID (M=3 in FIG. 3) from a multicast address (IP=A in FIG. 3), based on multicast domain information, and stores the multicast flow ID in the header-in-device. The packets of M=3 are copied, with reference to the copy table 1 in the switch card 30, based on information (I=1, 3) of the interface card 20 of the destination.

Specifically, in FIG. 3, the switch card 30 generates destination information of the interface card 20a, from information (I=1, 3) of the interface card 20 of the destination, and reads out packets. It is assumed that destination (I) in FIG. 3 corresponds to 1, 2, 3 . . . =a, b, c, . . . . Next, the switch card 30 generates destination information of the interface card 20c, and reads out packets. In addition, the switch card 30 discards the packets of which duplicate (read) is completed. Further, since the generation of the destination information and the reading out of packets by the interface card 20 can be simultaneously performed, second destination information (addressed to the interface card 20c) can be generated, when first packet (addressed to the interface card 20a) is read.

The switch card 30 may remove the destination information (I in FIG. 3) of the interface card 20 of the destination when transmitting packets to the interface card 20. Further, the destination information may be removed as information-in-device in the interface card 20 on the Egress side.

The interface card 20 on the Egress side that has received packets from the switch card 30 copies the packets of the number (three in FIG. 3 in the case of the interface card 20a) of destination ports, by referring to the copy table 2 in the interface card 20. In this case, information (for example, Q=5) indicating the destination is assigned to each copy packet, and is stored in the desired buffer in a shaper block (Shaper Scheduler in FIG. 3). Incidentally, after the destination (Q), the flow (M), and the like which are information-in-device are removed by the packet processing unit on the Egress side, packets are output.

The interface card 20 on the Egress side performs a copy process similar to copy in the switch card 30. Specifically, the copy process is performed based on information (Q=5, 7, 8 in FIG. 3) indicating the destination from the copy table to the output ports in the interface card 20a in FIG. 3. The interface card 20 first generates the destination information of the output port (Q=5), and then reads and transmits a packet (Payload+IP). Thereafter, the interface card 20 generates the destination information of the output port (Q=7), and reads and transmits packets. The interface card 20 generates the destination information of the output port (Q=8), and reads and transmits packets. After the duplicate (reading) of packets is finished, the packets are discarded. Further, the generation of the destination information and the reading of the packet are possible similar to the duplicate of the switch card 30, at the same time.

In the flow, the input packet is copied, and the same packet as the input packet can be output to a plurality of output ports.

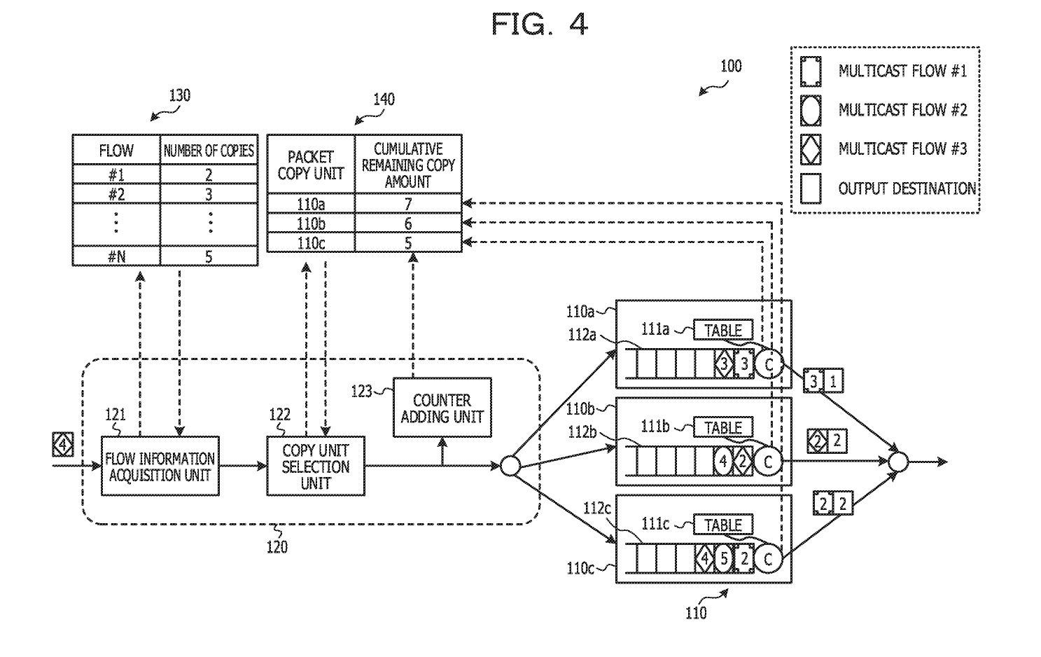

Here, a copy processing function in the packet relay device 1 of this embodiment will be described. The copy processing function is used when the switch card 30 in FIG. 3 distributes the packet to the interface card 20 on the Egress side, or when the interface card 20 on the Egress side outputs the packet to a plurality of output ports. A functional configuration diagram of the copy functional block 100 according to the present embodiment is illustrated in FIG. 4. The copy functional block 100 includes a plurality of copy units 110a to 110c, a load distribution unit 120, a flow information table 130, and cumulative remaining copy management table 140. In FIG. 4, the copy units 110a to 110c are simply referred to as a copy unit 110, when they are not distinguished. An example in which the number of copy units 110 is three is exemplified, but the number is not limited thereto. Further, Embodiment 1 is a case where a packet has a fixed length.

The flow information table 130 is a table holding the number of copies for each piece of flow information. The flow information is stored in the header-in-device, based on the header information of the packet. The cumulative remaining copy management table 140 indicates a counter (cumulative remaining copy amount) indicating the cumulative remaining copy amount which is the remaining copy amount of all stored packets in each copy unit 110 associated with each copy unit 110. In FIG. 4, the remaining copy amount for copy of a packet of a fixed length is set as the number of remaining copies. The flow information table 130 and the cumulative remaining copy management table 140 are stored, for example, in the memory 25 of FIG. 2.

For example, if the load distribution unit 120 performs distribution of a packet to the copy unit 110a, the copy amount of the packet is added to the cumulative remaining copy amount of the copy unit 110a, the packet is copied and transmitted by the copy unit 110a; and if the packet is transmitted, the copy amount of the transmitted packet is subtracted from the cumulative remaining copy amount of the copy unit 110a, such that the cumulative remaining copy management table 140 stores the cumulative remaining copy amount that is a normally correct value. Other copy units 110b and 110c also operate in the same way.

The load distribution unit 120 is configured with a flow information acquisition unit 121, a copy unit selection unit 122, and a counter adding unit 123. The flow information acquisition unit 121 acquires information on the number of copies of the flow from the flow information table 130, by using the flow-information-in-device for performing a packet process in an attached device based on information of the header of an arriving packet.

The copy unit selection unit 122 acquires the cumulative remaining copy amount of each copy unit 110 from the cumulative remaining copy management table 140, and selects a copy unit having the minimum cumulative remaining copy amount so as to determine the distribution destination of the packet. The counter adding unit 123 adds the cumulative remaining copy amount of the selected copy unit 110 by the number of copies of the flow, and updates the cumulative remaining copy management table 140.

For example, in the case of FIG. 4, if the load distribution unit 120 receives a packet, the flow information acquisition unit 121 acquires the number 2 of copies of the flow from the flow information table 130, by using the flow-information-in-device (flow=#2) based on header information of an arriving packet. If the flow information acquisition unit 121 acquires the flow information, the copy unit selection unit 122 acquires the cumulative remaining copy amount 7, 6, 5 indicated by the cumulative remaining copy counters of the respective copy units 110a to 110c, from the cumulative remaining copy management table 140. The copy unit 110c having the minimum cumulative remaining copy amount is a distribution destination, and at the time of distribution, the counter adding unit 123 adds three that is the number of copies to the cumulative remaining copy amount of the copy unit 110c, and updates the value of the cumulative remaining copy amount of the copy unit 110c to 8 (=5+3). The detailed description of load distribution will be described later.

The plurality of copy units 110 include copy tables 111a to 111c that manage the destination information and the number of copies of each flow, and storage units 112a to 112c for storing arriving packet, respectively. In addition, the copy tables 111a to 111c and the storage units 112a to 112c are simply described only by numbers, when they are not distinguished.

The copy unit 110 copies the first packet of the storage unit 112 and assigns destination information, based on the contents of the copy table 111. In addition, the destination assigning order of the copy packet of each of the plurality of copy units 110 is the same for each flow of the packet in each copy unit 110.

Here, a load distribution method will be described in detail. The load distribution itself has a long history, and more various methods have been considered than before. The load distribution method is, for example, a load balancer for a server or the like, which regards a plurality of Web servers as one virtual server, and distributes packets based on various values that vary at every moment, such as the minimum number of connections, a minimum load, and the like.

In addition, examples of another load distribution method include link aggregation (LAG) that regards a plurality of links as one link, and equal cost multi path (ECMP) for distributing IP packets to paths of the same cost. In these methods, a probabilistic load distribution for determining an output port based on the hash value obtained by applying the address information and the like such as a MAC address or an IP address to the hash function is generally performed.

Examples of important requirements for the load distribution in the packet relay device are not to cause an order reversal of a packet in the same flow (for example, a user unit identified by a VLAN ID, and the like). Hereinafter, a description of the load distribution method will be made by describing only some functions.

In a case of a method using various hash values that have been used in link aggregation for load distribution in the related art, since packets belonging to the same flow have the same address, the hash values are the same, and are distributed to the same copy unit 110. Thus, the order of the packet can be protected. However, when the distribution of a packet depends on the probability, or the rate of only a specific flow is high, there is a possibility that the packet is biased in some copy units 110.

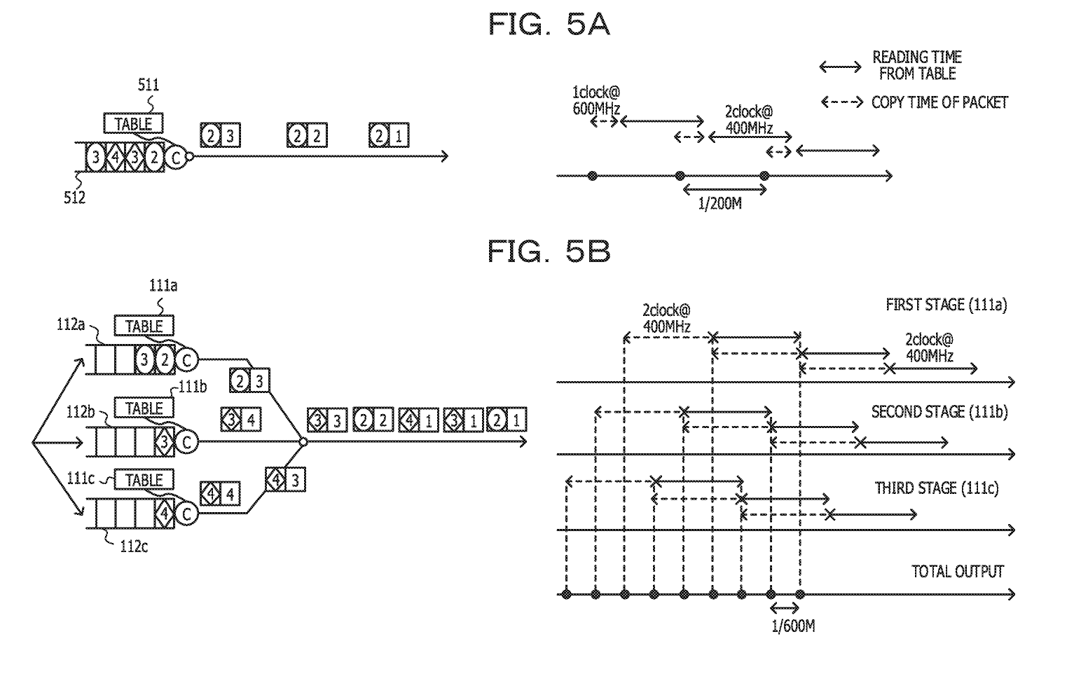

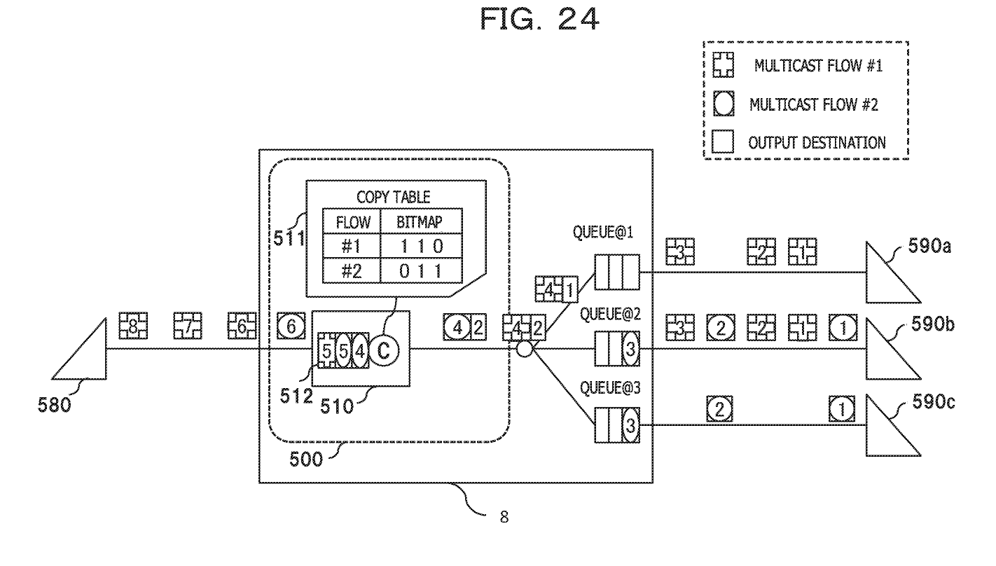

The problem in this case will be described with reference to FIGS. 5A and 5B. A packet of a fixed length in FIGS. 5A and 5B is considered as a packet of the shortest length (64 bytes). FIG. 5A illustrates a case where the number of copy units 510 in the related art is one as in FIG. 24, and FIG. 5B illustrates a case where the number of copy units 510 is plural (three in FIG. 5B) as in FIG. 4. Further, searching for the table based on FIGS. 5A and 5B and assigning destination information are performed at 400 MHz for two clocks (=200 MHz) from the limit of the operation clock.

In contrast, when the packet length is short, for example, when the packet length is 64 bytes as in FIGS. 5A and 5B, it is possible to perform a reading process of the packet, with one operating clock of 600 MHz. Therefore, the time for duplicating depends on searching for in-device destination information from a table, based on the flow number in the device.

This means that a table has to be accessed to search for information of the corresponding flow number, thus it takes a longer time as compared to duplicating of a type of reading the packet, and the time is two clocks (=200 MHz) at 400 MHz.

This causes a reduction in the throughput (bps) in the device when the packet length is short, by searching for the in-device destination information from the table, based on the flow number in the device.

In each copy unit 110 of FIG. 5B, a time taken for by accessing the copy table 111 and for assigning a destination in the device, based on the information of the copy table 111, is two clocks (=200 MHz) at 400 MHz, similar to the copy unit 510 in FIG. 5A.

However, it is possible to achieve the same effect as at 600 MHz, when combining the outputs of the respective copy units 110. In addition, in the duplicating and sending of a packet of 64 bytes, it is also possible to read a packet with one clock of a clock frequency of 600 MHz, but if the packet length increases, the throughput (bps) of the output (for example, 1024 bytes of a fixed-length) increases. Therefore, in the process in the packet relay device, only duplicate may be performed fast, and the copy packet relay device has difficulty in processing a packet.

Therefore, the output of 400 Gbps is obtained regardless of the packet length by reading 64 bytes for two clocks at the operation clock of 400 MHz. That is because for example, if it is intended to duplicate the packet of the packet length of 1024 bytes at the operation clock of 400 MHz for two clocks, reading is performed 16 numbers of times. However, since the outputs for 16 numbers of times from the packet relay device 1 are summed and output, this does not affect the throughput. Therefore, it is possible to obtain the output of 400 Gbps, regardless of the packet length, by reading 64 bytes with two clocks at 400 MHz. In addition, it is desired to avoid the outputs of the plurality of copy units 110 from being duplicated during combination thereof.

At this time, the processing performance (copy time) in terms of an individual copy unit is a clock speed of two clocks at 400 GHz which is dropped from 600 MHz of FIG. 5A by one clock, and the same effect is achieved as compared to FIG. 5A. Further, it is possible to obtain a fixed throughput (bps) regardless of a packet length. Moreover, since a plurality of copy units are used, the limit in the throughput due to the limit of the operation clock can be solved.

However, when it is intended to output the same performance by using three copy units as the performance in using one copy unit, if deviation occurs in one copy unit, the copy performance is lower than in using one copy unit, the processing performance of the copy function is deteriorated, and this causes a problem in that the speed of the entire packet relay device is dropped.

FIGS. 5A and 5B illustrate a case of using three copy units, but the number of copy units, the operating clock frequencies of the copy units, or the operating clock frequency of reading of a table may be adjusted to the throughput which is obtained in the final output.

In addition, when applying a dynamic load equalization method using the concept of a server load balancer, the method regarding that “waiting queue length”=“load state”, and transmitting packets to the copy functional block having the shortest queue (=minimum load copy unit), the shortest queue is selected at all times, and it is likely that even distribution of loads of each copy unit 110 is optimally performed. However, the order may not be protected by the copy pattern in this method. Note that the queue length indicates the packet length, and hereinafter, the packet length may be referred to as the queue length.

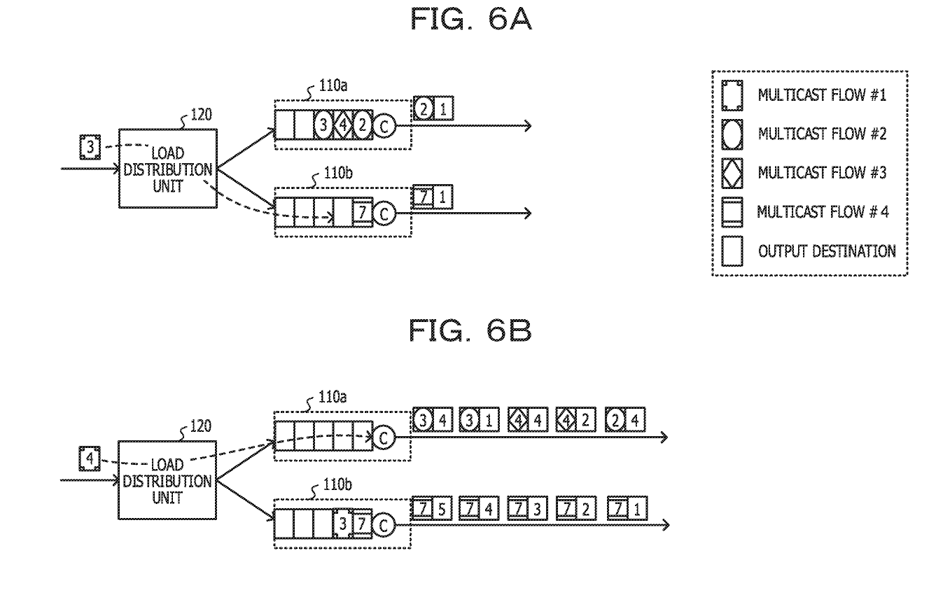

The reason for this will be explained with reference to FIGS. 6A and 6B. FIGS. 6A and 6B illustrate the copy functional block using two copy units 110. In FIG. 6A, since the queue length of the copy unit 110b is short at the time of arrival of the third packet in the multicast flow #1, the packet is distributed to the copy unit 110b. However, when time is taken in the process having the large number of copies of a packet (the seventh packet in the multicast flow #4), a long queue may be processed as in FIG. 6B (FIGS. 6A and 6B are considered as a fixed length packet.)

In other words, if the fourth packet in the multicast flow #1 arrives, in a state of FIG. 6B, the packet is distributed to the upper copy unit 110 with a short queue, and as a result, the packet may be sent before the third packet. In other words, in this method, it may not be possible to secure the order in the same flow.

In the load distribution method as described above, if the packets in the same flow are fixed to a single copy unit 110, the even distribution is not satisfied; and if the packets are distributed to the plurality of copy units 110, the order in the same flow is not satisfied.

Therefore, consideration has to be given to the distribution method focusing on the characteristics of the packet copy. Since the packet copy as illustrated in FIGS. 6A and 6B are a process of increasing a single packet into a plurality of packets, there is a characteristic in which an apparent queue length and a substantial queue length are different.

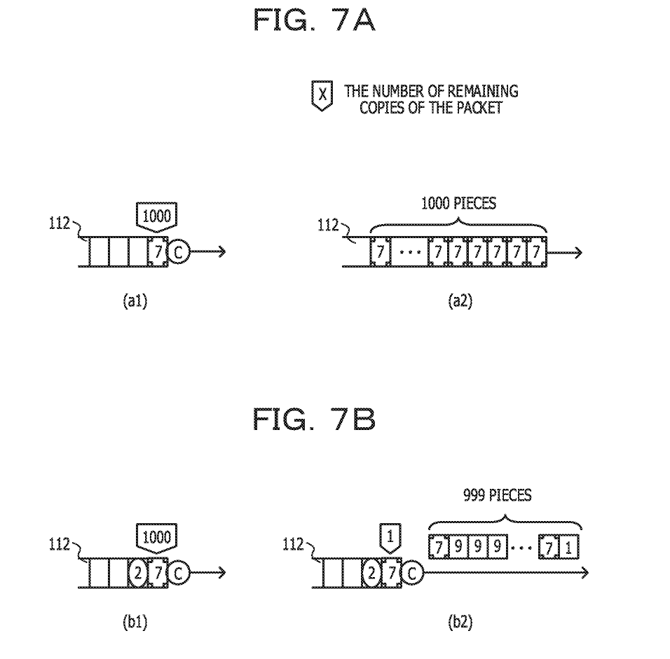

For example, as in FIG. 7A, the processing times are equal in a state (a1) in which a packet to be subjected to being copied into 1000 pieces is located in the beginning of the storage unit 112 and in a state (a2) in which 1000 non-copy packets are virtually stored in the storage unit 112. In other words, when the copy target is a fixed length, the processing time of one packet is proportional to the number of copies.

With respect to a packet that is being copied, there is a characteristic in which the load situation is different depending on how many copies are performed. For example, In FIG. 7B, (b1) and (b2) have the same situation in which a packet to be duplicated 1000 pieces is located in the beginning of the storage unit 112, but the process starting times of the subsequent packet are totally different in the first duplicate (b1) and the 1000-th duplicate (b2). (For a part of FIGS. 7A and 7B, the number of remaining copies is omitted). In other words, the cumulative value of the number of remaining copies changes from time to time by the arrivals and the copy processes of packets having a different number of copies, and it may be said that the cumulative value represents a substantial queue length, and is an index properly representing the load state of the copy unit 110.

Therefore, a load distribution method is desired which dynamically manages the cumulative remaining copy amounts of all the packets that have been queued for each copy unit 110, and distributes the arriving packet to copy unit 110 having the minimum cumulative remaining copy amount.

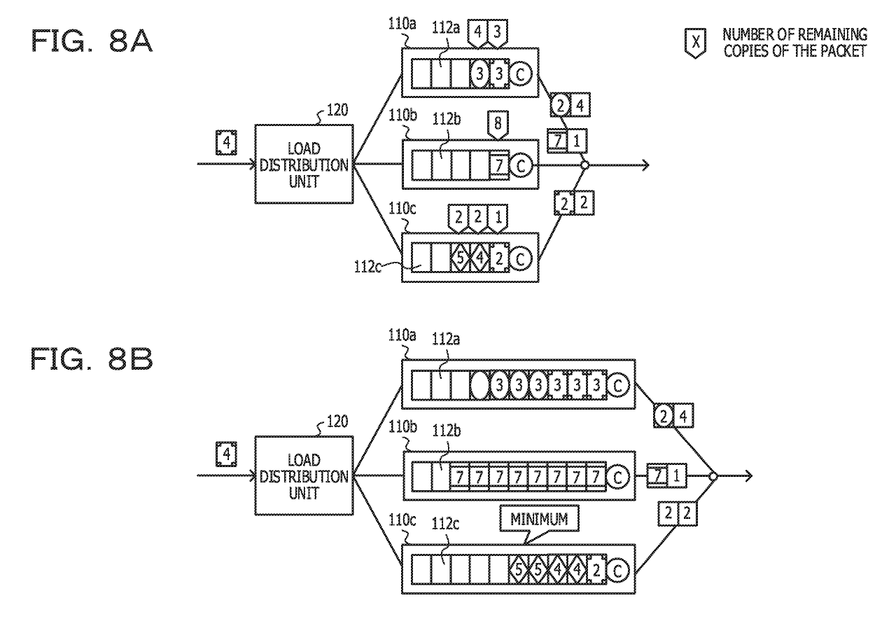

Further, when the cumulative remaining copy amounts are the same, it is assumed that the packet subjected to the distribution process is sent to the copy unit 110 which can send the arriving packet earlier. FIGS. 8A and 8B depict the concept of the method. FIG. 8A is an aspect of the queue in a normal copy functional block, and the number above the stored packet in the storage unit 112 represents the number of remaining copies of each packet.

FIG. 8B illustrates a state of a virtual (substantial) queue of a substantial length which is obtained through conversion based on the number of remaining copies of each stored packet. This clarifies the copy units 110 having substantially less load, and a packet is distributed to the copy unit 110.

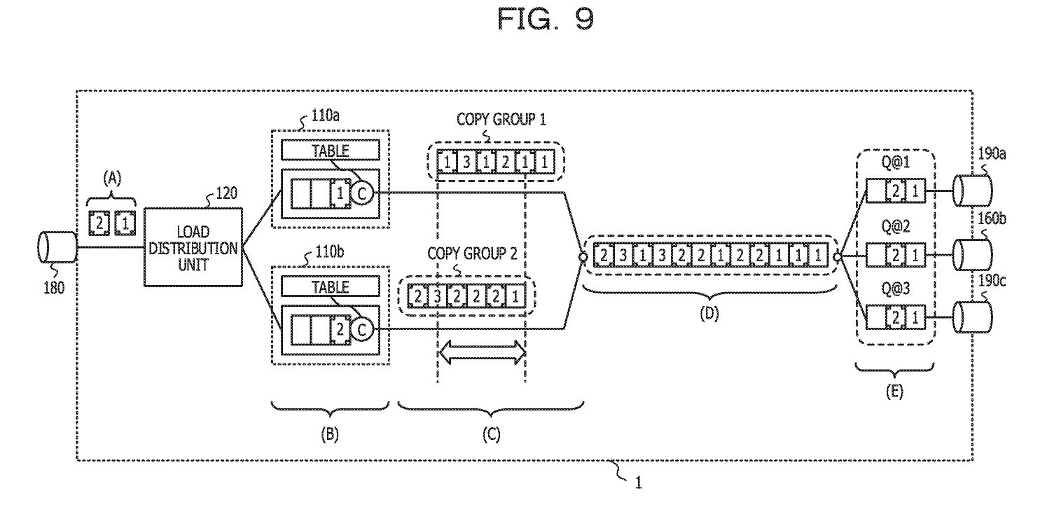

Further, since the arriving packet is sent at all times to the copy unit 110 of the minimum substantial queue, if the destination orders of the respective copy units 110 at the time of copy are maintained to be equal, the order can be secured. For example, as in FIG. 9, it is assumed that packets [1] and [2] (respectively indicating the first packet and the second packet) of the same flow reach the packet relay device 1 in series (state (A)). Incidentally, FIG. 9 illustrates the case of having two copy units, similar to FIGS. 6A and 6B. In addition, in the packet relay device, a packet is input from the input port 180, and a packet is output from the output port 190.

[1] and [2] are respectively sent to the minimum substantial queues at that time, for example, when they are sent to different packet copy units 110 as the state (B), [1] starts duplicate earlier in accordance with the principle described above, but the copy of [2] is started during the copy of [1], and overlapping of the copy periods may occur (state (C)).

If these packet groups are multiplexed, a packet stream is obtained in which [1] and [2] are mixed as in the state (D), and partially is in a state in which [2] precedes [1]. However, if the destination orders at the time of copy are the same, the orders of [1] and [2] are maintained, in terms of units of destinations, such that after the packet is distributed to respective output routes as the state (E), the orders of [1] and [2] are as in the output (Q@1, Q@2, and Q@3) of each route.

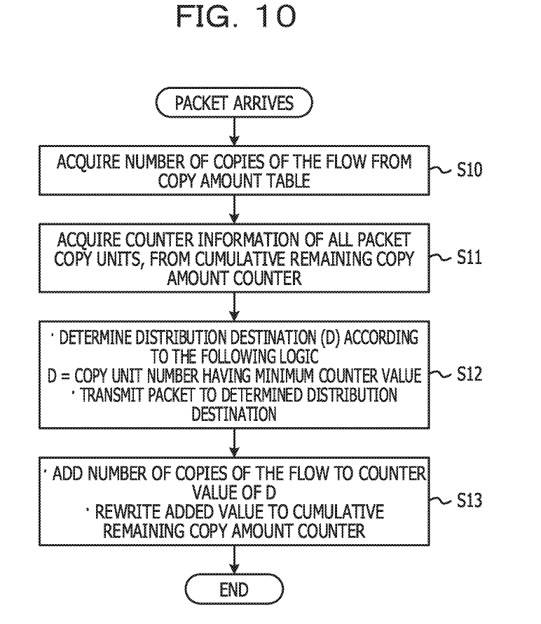

The retention of cumulative remaining copy amount of the cumulative remaining copy management table 140 will be described in detail by using examples of the flowcharts of the load distribution unit 120 and the copy unit 110. First, an example of the flowchart of the load distribution unit 120 is illustrated in FIG. 10. If a packet arrives, the number of copies of the flow is acquired from the flow information table 130 based on the flow-information-in-device associated based on the header information of the packet (S10). Next, the cumulative remaining copy amounts of all copy units 110 are acquired from the cumulative remaining copy management table 140 (S11). The packet is sent to the copy unit 110 having the minimum cumulative remaining copy amount (S12).

The packet is sent to the distribution destination, and at the same time, the cumulative remaining copy amount of the copy unit 110 in the cumulative remaining copy management table 140 is updated by adding the number of copies of the packet to the cumulative remaining copy amount of the copy unit 110 which is a transmission destination (S13).

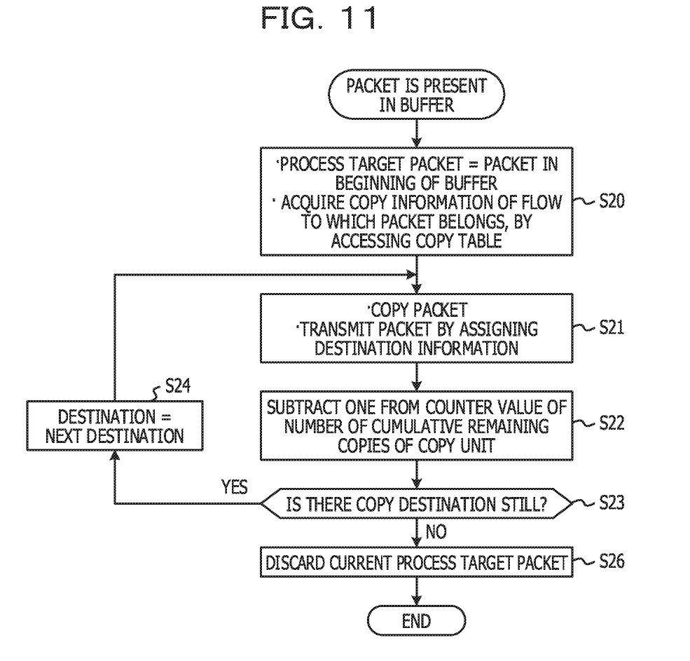

Next, an example of the flowchart of the copy unit 110 is illustrated in FIG. 11. If there is a packet in the storage unit 112 of the copy unit 110, the number of copies of the flow, to which a process target packet (a packet in the beginning of a buffer) belongs, is obtained by accessing the copy table 111 (S20).

The corresponding packet is copied, and is sent by giving the destination information to the copy packet (S21). The amount of the transmitted packets is subtracted from the cumulative remaining copy amount of the copy unit 110 (when the number of copies managed, for example, 1 is subtracted from the counter value of the number of the cumulative remaining copies whenever transmitting one packet) (S22).

It is checked whether or not the copy destination of the packet remains (S23). In the case of remaining (S23: Yes (present)), the destination is changed to the next destination (S24), and the operation from S21 is repeatedly performed. In the case of not remaining (S23: No (absent)), the current processing target packet is discarded (S25).

As described above, the cumulative remaining copy amount of each copy unit 110 is correctly maintained by adding and subtracting the cumulative remaining copy amount of each copy unit 110 at each process from the load distribution unit 120 and the copy unit 110.

In addition, the subtraction method of the cumulative remaining copy amount is not limited to this method, and for example, the number of copies may be subtracted by being summed (distinguished by time) to some extent.

Further, the addition method of the cumulative remaining copy amount is not limited to this method, and for example, the number of copies may be added when the packet is input to the storage unit 112 of the copy unit 110.

Moreover, the cumulative remaining copy amount may be updated by summing the addition and subtraction results in the copy unit 110.

With the above configuration, with respect to the packet that has been input to the packet relay device 1, since the load distribution unit 120 selects the copy unit 110 of the minimum cumulative remaining copy amount from the cumulative remaining copy amount of the respective copy units 110a to 110c, it is possible to maintain the order in the same flow in addition to the possible distribution of the copy quantity.

In addition, it is possible to have a copy performance capable of coping with the limit of the throughput of the output due to a limit of the operating clock.

### Modification Example of Embodiment 1

When the number of copy units in the related art is one as described in FIGS. 5A and 5B, if the packet length is short, a time taken for copy in the packet relay device is the time taken for searching for the in-device destination information from the table, based on the flow number in the device, and for assigning the destination information.

Accordingly, the assigning of the in-device destination information from the table is distributed using the fixed pointer. In this case, the packet body is stored in the memory or the like, and is read thereafter. In this case, even if the packet length is long, since the reading of 64 bytes can be read at one clock, using an operational clock of 600 MHz, a reduction in the throughput of the output does not occur. For example, four clocks are desired for reading of a packet length of 256 bytes (64×4). However, since the output also becomes four times 256 bytes, the throughput of the output is not reduced.

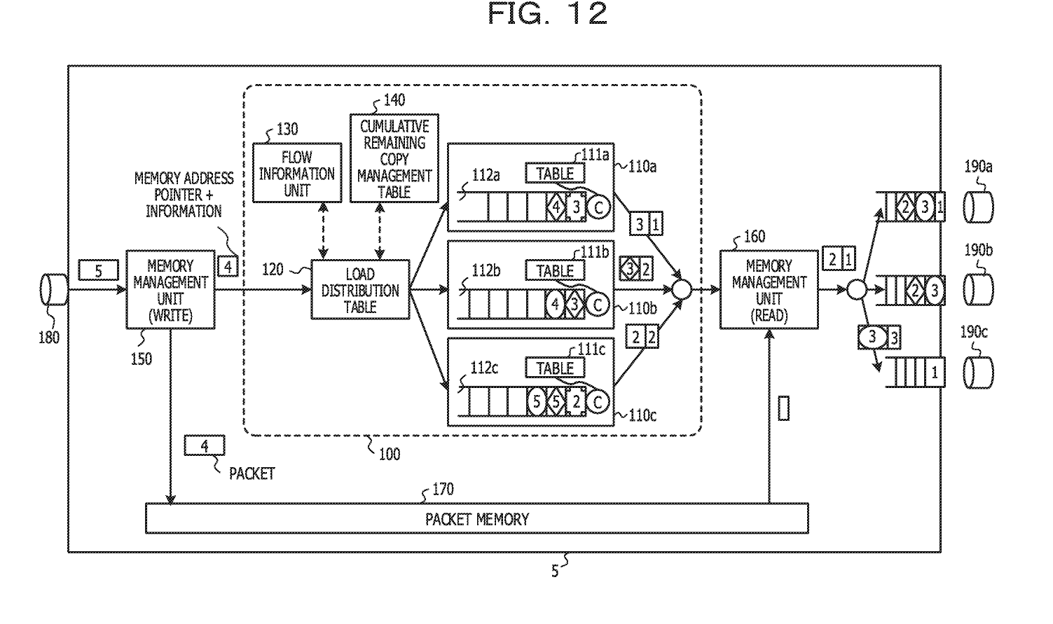

FIG. 12 is a diagram illustrating a packet relay device 5 that distributes a packet using a fixed pointer, by the copy functional block 100. In the packet relay device 5, a memory management unit (write side) 150 and a memory management unit (read side) 160 are provided before and after the copy functional block 100. An input packet is divided into a packet body and a memory address by the memory management unit (write side) 150, and stores the packet body in the packet memory 170. The packet body may be a variable-length packet or a fixed-length packet. Further, in the packet relay device 5, a signal is input from the input port 180, and signal is output from the output ports 190a to 190c.

A pointer indicating the memory address in place of the stored packet body is passed to the copy functional block 100. As well as the pointer, information desired for a process such as the flow information is passed to the copy functional block 100 in practice. Since an information packet including such a pointer is typically a fixed length of a small number of bytes, it may be processed in the same manner as the fixed length packet. Note that after performing the copy process or other processes (shaping, scheduling, and the like), a packet body is read from the packet memory 170 based on the pointer information by the memory management unit (read side) 160.

According to the above configuration, it is possible to acquire information from the table, and perform a process by distributing a time taken for assignment.

### Embodiment 2

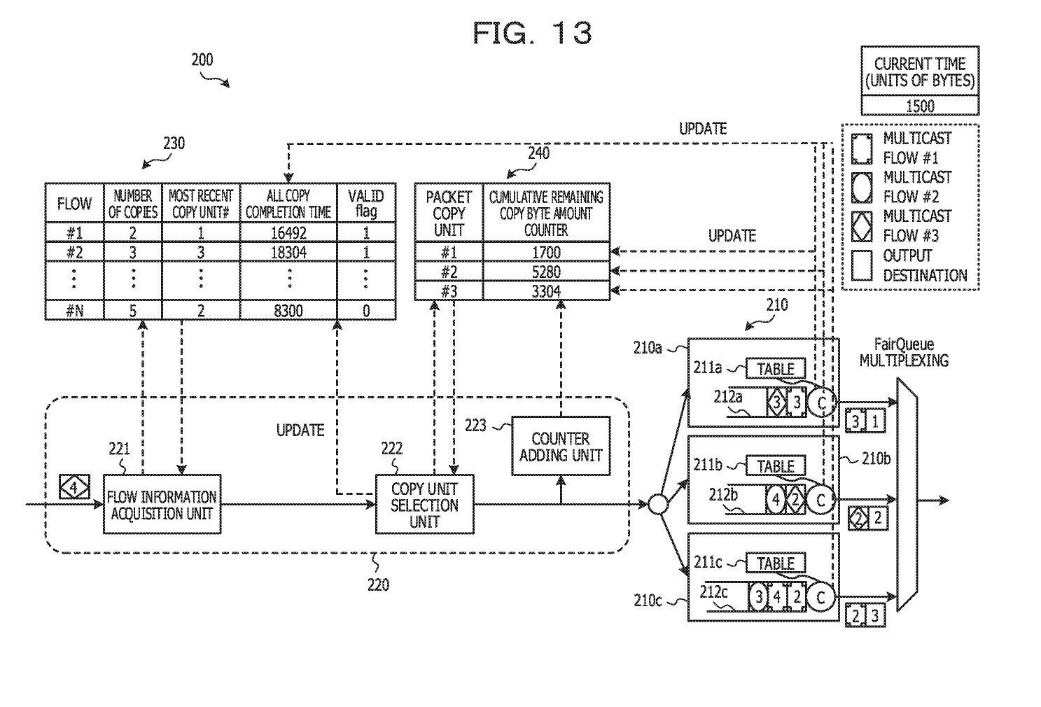

FIG. 13 illustrates the configuration of a copy functional block 200 according to Embodiment 2. The copy functional block 200 of Embodiment 2 includes a plurality of copy unit 210, a load distribution unit 220, an cumulative remaining copy management table 240, and a flow information table 230. If the copy units 210 are not distinguished in the same manner as Embodiment 1, the copy units 210 are described only by a number. If configuration requirements other than the copy unit 210 are not distinguished in the same manner, they are described by a number.

The configurations of the copy unit 210 and the load distribution unit 220 are almost the same as the configurations of the copy unit 110 and the load distribution unit 120 in FIG. 4. The cumulative remaining copy management table 240 has the cumulative remaining copy amount of each copy unit. In Embodiment 2, the copy amount is managed using the number of bytes. The reason why the management is performed using the number of bytes is that in the case of a variable-length packet, (as FIGS. 5A and 5B, when a minimum packet length is equal to or higher than a time taken for searching the table and assigning the destination), since the packet length gives an impact to the copy time (=substantial queue length), the order reversal occurs in the simple management of the cumulative number of copies.

For example, a time taken to duplicate a packet of 200 bytes to transmit the packet is twice the time taken to copy a packet of 100 bytes. The reason of considering the copy will be described with reference to FIGS. 5A and 5B. A time taken for copy and transmission may be equal to or greater than the time taken for table searching in the shortest packet length. In short, the clock frequency and the number of clocks used in the copy of the packet of the shortest packet length may be equal to or less than the clock frequency and the number of clocks used in the table searching. For example, as FIG. 5B, since the shortest packet is copied using an operation clock of 400 MHz by two clocks, it is possible to duplicate by the number equal to or more than the number of copies when information of a destination in the device is acquired from the copy table.

The flow information table 230 has the most recent copy unit number of destination copy unit information of the most recent packet of the same flow, an total copy completion time of all copies for each flow, and a valid flag indicating the presence or absence of a packet of each flow in a plurality of copy units 210, in addition to the number of copies for each flow. In the case of a variable-length packet, as mentioned above, since there are cases of not avoiding the order reversal if determination is performed only by the cumulative remaining copy amount, information on the most recent copy unit number, the total copy completion time, and the valid is newly desired.

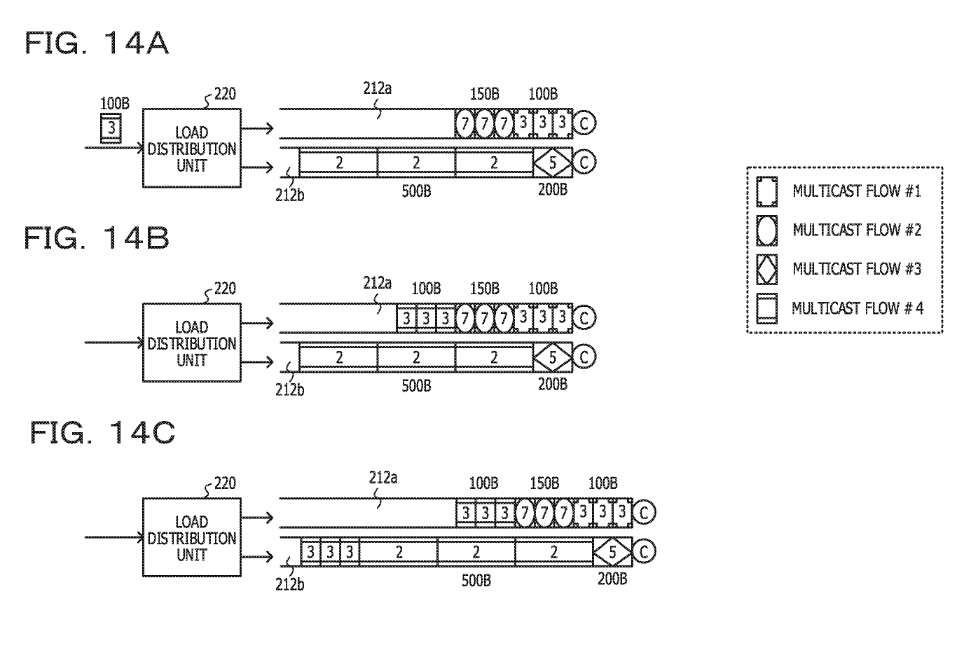

A problem in the order reversal at the time of variable-length packet will be described with reference to FIGS. 14A to 14C. For the sake of clarity, FIGS. 14A to 14C illustrate an aspect of a queue at the time of substantial queue (virtual queue) conversion. FIGS. 14A to 14C illustrate a state in which the second packet (hereinafter, expressed as [2]) of 500 bytes and the third packet (hereinafter, expressed as [3]) of 100 bytes, of the multicast flow #4 having three numbers of copies, arrive in series. Since the length of the substantial queue of the lower copy unit is small at the time when [2] arrives, [2] is distributed to the storage unit 212b of the copy unit 210b (a).

The first copy of [2] starts after 200 bytes from the current time and is completed after 700 bytes. In other words, since this packet has a length of 500 bytes, it takes a time of 500 bytes for one packet duplicate. Thus, a time when the second copy is completed is a time of 1200 bytes from the current time (200+500×2).

Meanwhile, since the substantial queue is shorter at the time of arrival of [3], [3] is distributed to the storage unit 212a of the copy unit 210a (b). With respect to [3], a time when the first copy has been completed is a time of 850 bytes, and the first copy of [2] is earlier than the first duplicate. However, since this packet has a length of 100 bytes, a time when the second copy is completed is a time of 950 bytes (750+100×2). In other words, with respect to the second packet, [3] that is scheduled to be sent later is sent earlier. Further, even in the third duplicate, [2] is copied after 1700 bytes, [3] is copied after 1050 bytes, and the order reversal occurs similar to the second duplicate.

In order to avoid such an order reversal in the same flow, in the flow information table 230, information (the most recent copy unit number) indicating a copy unit 210 to which the most recent packet for each flow has been sent, and scheduled time information (total copy completion time) indicating the completion of all copies for the packet are added.

When the order reversal occurs from the information (the most recent copy unit number) indicating a copy unit 210 to which the most recent packet for each flow has been sent and the scheduled time information (total copy completion time), the packet is distributed to the same flow as illustrated in FIG. 14C.

If the transmission completion scheduled time when the arriving packet is distributed to the copy unit 210 having the minimum cumulative remaining copy byte count value is larger than the transmission completion scheduled time of the most recent packet of the flow, that is stored in the flow information table 230, the load distribution unit 220 sends the arriving packet to a copy unit 210 having a minimum cumulative remaining copy amount, or when the cumulative remaining copy amounts are the same, the load distribution unit 220 sends the arriving packet to a copy unit 210 that sends a packet earlier than the time of packet multiplexing.

Further, when the cumulative remaining copy amount is small, it is assumed that the arriving packet is sent to a copy unit 210 that has sent the most recent packet stored in the flow information table 230.

Since a valid flag indicating the presence or absence of a packet for each flow in the plurality of copy units 210 is used, it is possible to send a flow which does not have to be contrasted to the copy unit 210 having a minimum cumulative remaining copy byte counter value without comparison. It is assumed that the packet reading from each copy unit 210 is read in accordance with a fair queuing algorithm.

Through the configuration and the distribution method described above, if the cumulative remaining copy amount is the number of bytes, even if a packet is distributed to the minimum copy unit 210, in a case where an order reversal does not occur, the packet is distributed to the copy unit 210, in a case where the order reversal occurs, the packet is distributed to the same copy unit 210 as in the most recent packet of the same flow, such that the order reversal can be avoided, even in the case of a variable-length packet, the order in the same flow and the equalization of a load of each copy unit 210 can be aimed than in the related art.

The update of a value for correctly securing the information in the cumulative remaining copy management table 240 of Embodiment 2 will be described using examples of the flowcharts of the load distribution unit 220 and the copy unit 210.

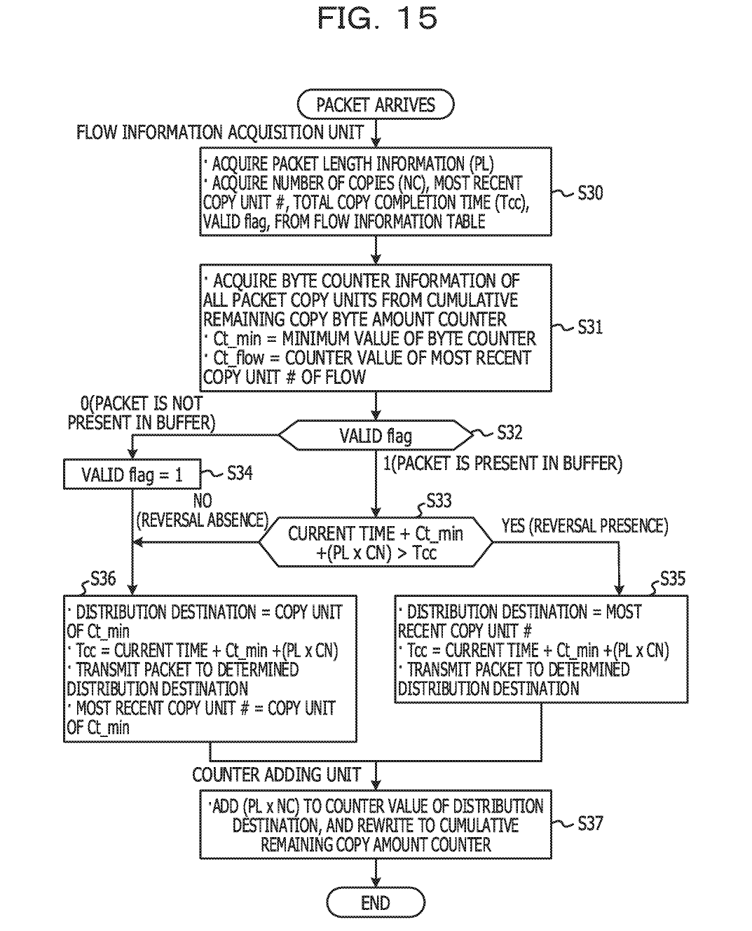

FIG. 15 illustrates an example of a flowchart of the load distribution unit 220.

If a packet arrives, the flow information acquisition unit 221 acquires packet length information (Packet Length: PL) of units of bytes of the arriving packet, the number of copies information (Number of Copy: NC) from the flow information table 230, most recent copy unit number, total copy completion time information (Time of copy complete: TCC), and flow information such as a valid flag, respectively (S30). Incidentally, if the packet is padded (a process of adding meaningless data before and after short data and matching the length), the length including the padding portion is PL.

Next, the cumulative remaining copy amount (the number of cumulative remaining copy bytes) information of all of the copy units 210 is acquired by accessing the cumulative remaining copy management table 240, and a counter value of the copy unit 210 of the minimum value (Minimum Counter: Ct_min) of the cumulative remaining copy amount and the counter value (Counter of this flow: Ct_flow) of the most recent copy unit number of the flow are found out (S31).

Next, the valid flag is confirmed (S32). The valid flag is a flag indicating whether or not the arriving packet and the previous packet of the same flow are still present in the copy unit 210. In the case of valid flag=0, since the packet of the same flow is not present in any copy unit 210, the order reversal does not have to be worried about, distribution is possible without worrying about the order reversal, and the valid flag of the corresponding flow is rewritten to “1” (S34). The packet distribution destination copy unit is a copy unit 210 having information of Ct_min, and total copy completion time information and the most recent copy unit information of the copy unit 210 are updated and are transmitted to the distribution destination copy unit 210 (S36).

Meanwhile, in the case of valid flag=1, since the previous packet is still in the storage unit 212 associated with the copy unit 210, it is desired to perform calculation such that the order reversal does not occur. The time, when the reading of the most recent packet of the same flow is completed, is managed as the total copy completion time information in the flow information table. When the arriving packet is distributed to the copy unit 210 of Ct_min, if the reading completion time is smaller than total copy completion time information, the arriving packet of the latter is read and completed earlier, and the order reversal occurs. In such a case, a packet is not distributed to Ct_min.

In the case where a packet is distributed to the copy unit 210 of Ct_min, the time when the reading of the arriving packet is completed can be expressed by the following Expression.

Arriving packet reading completion time=current time+Ct_min+(PL×NC) Expression 1

The current time is the value of the time counter with bytes as units. Logically, the time counter is added by one every time data of one byte amount is read. Since Ct_min is a byte counter value of a minimum counter, of course, it takes time of units of bytes of Ct_min amount such that all packets of the buffer are copied. Here, if an arriving packet is input, it takes time of packet length×the number of copies (PL×NC), such that the final reading completion time of the arriving packet is the sum of the current time and the number of remaining copy bytes of the distribution destination copy unit 210, and packet length×the number of copies (PL×NC).

In the case of arriving packet reading completion time>total copy completion time information (S33: No (order reversal is not present)), the order reversal does not occur, such that a packet distribution destination copy unit is the copy unit 210 having information of Ct_min, total copy completion time information of the flow and the most recent copy unit information are updated and transmitted to the distribution destination copy unit 210 (S36).

Meanwhile, the arriving packet reading completion time>total copy completion time information (S33: Yes (reversal is present)), the packet distribution destination is the copy unit 210 that has sent the most recent packet, and the value of total copy completion time information of the flow is rewritten and transmitted (S35).

When a packet is transmitted to the distribution destination (after S35 and S36), the cumulative calculation copy amount is updated by adding (PL×NC) to the cumulative calculation copy amount of the distribution destination (S37).

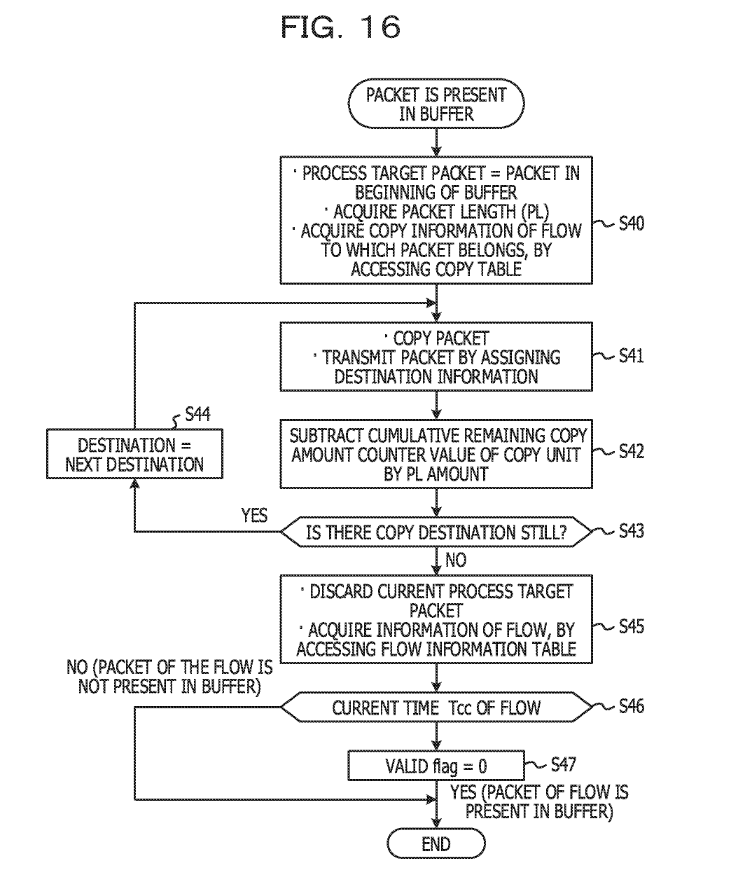

Next, FIG. 16 illustrates an example of a flowchart of the copy unit 210 of Embodiment 2. If a packet is in the storage unit 212, each copy unit 210 starts a copy process on the top packet. First, after acquiring a packet length (PL), copy information (destination information and the like) of the flow to which the packet belongs, by accessing the copy table 211 (S40).

The packet is copied, and is transmitted by giving destination information to the packet (S41). If the packet is transmitted, the cumulative remaining copy amount (the number of cumulative remaining bytes) of the packet copy unit 210 is subtracted by a PL amount (S42).

The presence or absence of the remaining copy destination of a packet is confirmed (S43). When a copy destination remains (S43: Yes), the copy destination is shifted to the next destination (S44), and a process from S41 is performed. Further, all copies are completed (S43: No), the current processing target packet is discarded, and information of the total copy completion time (Tcc) and the like of the flow is acquired by accessing the flow information table 230 (S45).

The magnitude relationship between the current time and the total copy completion time information of the flow is confirmed (S46). When the current time is larger (S46: Yes), all of the flow copy of the flow is completed at the present time, and since a packet is not present in the storage unit 212 associated with the copy unit 210, the valid flag is updated to “0” (S47). If the current time is the total copy completion time information or more (S46: No), this indicates a copy standby packet of the flow is still in the storage unit 212, and the process is completed without updating the value, in particular.

The cumulative remaining copy amount of the cumulative remaining copy management table 240, the most recent copy unit of the flow information table 230, the total copy completion time, and the valid flag can be correctly updated, through the respective processes from the flowcharts of the load distribution unit 220 and the copy unit 210 described above.

In addition, the load distribution unit 220 considers only the copy unit 210 to which a packet of a minimum amount is distributed, but any copy unit 210 may be considered. In that case, the distribution may be performed from the copy unit having a small cumulative remaining copy amount (the number of cumulative remaining bytes) in order. Further, S31 and S32 are reverse to each other, and the counter value of copy unit of the minimum value (Minimum Counter: Ct_min) of the cumulative remaining copy amount after checking the valid flag, and the counter value (Counter of this flow: Ct_flow) of the most recent copy unit number of the flow may be calculated.

Further, the valid flag may not be used. In this case, even if a packet of the same flow is not present in the copy unit 210, the load distribution unit 220 calculates the arriving packet reading completion time (=current time+Ct_min+(PL×NC)) and compares it with total copy completion time information so as to determine a destination. (If the same flow does not remain, the amount of total copy completion time information is smaller than the current time, such that distribution is possible at minimum). Since there is no valid flag, the copy unit 210 does not update the valid flag.

Further, the variable-length packet is illustrated as an example, even in the case of the fixed-length packet, the number of bytes may be managed. In this case, the same workflow is possible, and a method of subtracting information such as the most recent copy unit, the total copy completion time, and the valid flag from the flow information table 230 may be used.

### Embodiment 3

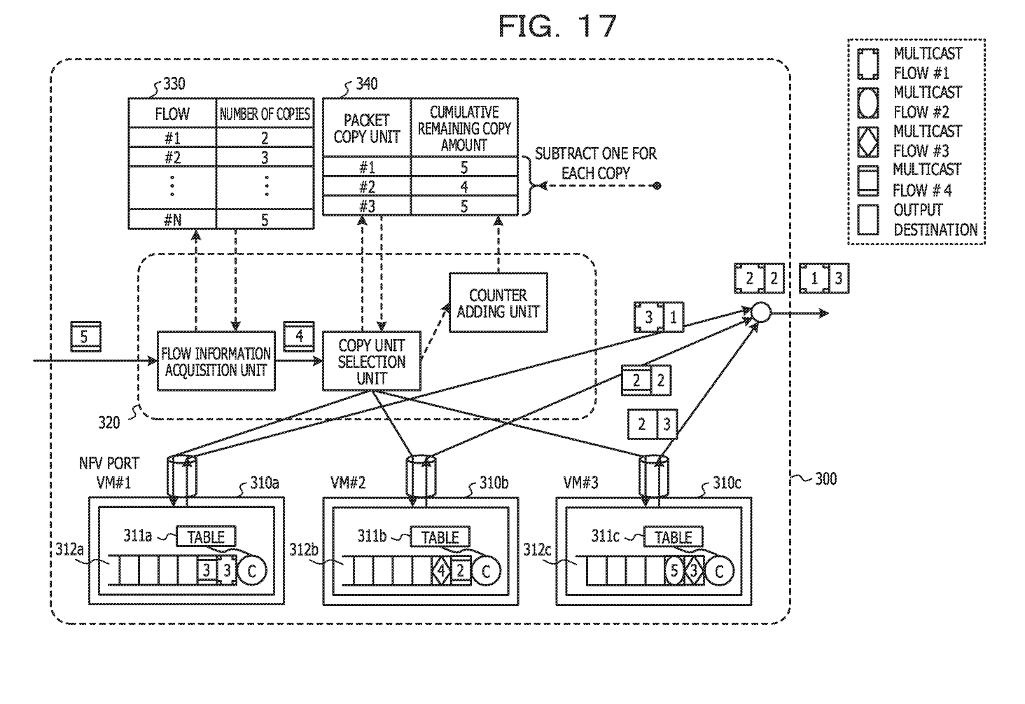

FIG. 17 illustrates the configuration of a copy functional block 300 of Embodiment 3. FIG. 17 illustrates a case in which the copy unit 310 is in the outside of the packet relay device, and an example of the copy unit 310 in the outside is a network function virtualization (NFV), but Embodiment 3 is not limited thereto. The copy functional block 300 includes a load distribution unit 320, a flow information table 330, a cumulative remaining copy management table 340 which are in the inside of the packet relay device, and a plurality of copy units 310 in the outside. Further, also in Embodiment 3, a plurality of configuration components are simply referred to as only number, when they are not distinguished.

The flow information table 330 is almost the same as the flow information table 130 in FIG. 4. The cumulative remaining copy management table 340 holds the destination information and the cumulative remaining copy amount of each copy unit 310 of the distribution destination. The destination information is held, for example, as the number of the copy unit 310. Alternatively, the load distribution unit 320 determines a copy unit 310 other than the distribution destination, based on the information of the cumulative remaining copy management table 340, and outputs the packets by assigning destination information (destination address) of the copy unit 310.

A plurality of copy units 310 are, for example, an external server or a virtual machine (VM), and copy packets. The packets that are copied by the copy units 310a to 310c (VM #1 to VM #3) are return again to the packet relay device, and output from each output port.

Further, the cumulative remaining copy amount of the each copy unit in the cumulative remaining copy management table 340 is maintained, for example, by adding the copy amount to the cumulative remaining copy amount, when a packet is transmitted to the copy unit 310; and by subtracting the copy amount of the copy unit 310, when a packet is received from an external copy unit 310. Further, for the determination of the copy unit 310 at the time of subtraction, the copy unit 310 of the transmission source is determined based on the transmission source information on a copy packet, when the copy packet is transmitted, for example, from the copy unit 310 to the packet relay device.

Through the above configuration, in addition to the order of the same flow, and the equalization of the load, since the external copy unit 310 performs the copy function with the load, it is possible to achiever the reduction of the load of the packet relay device.

### Embodiment 4

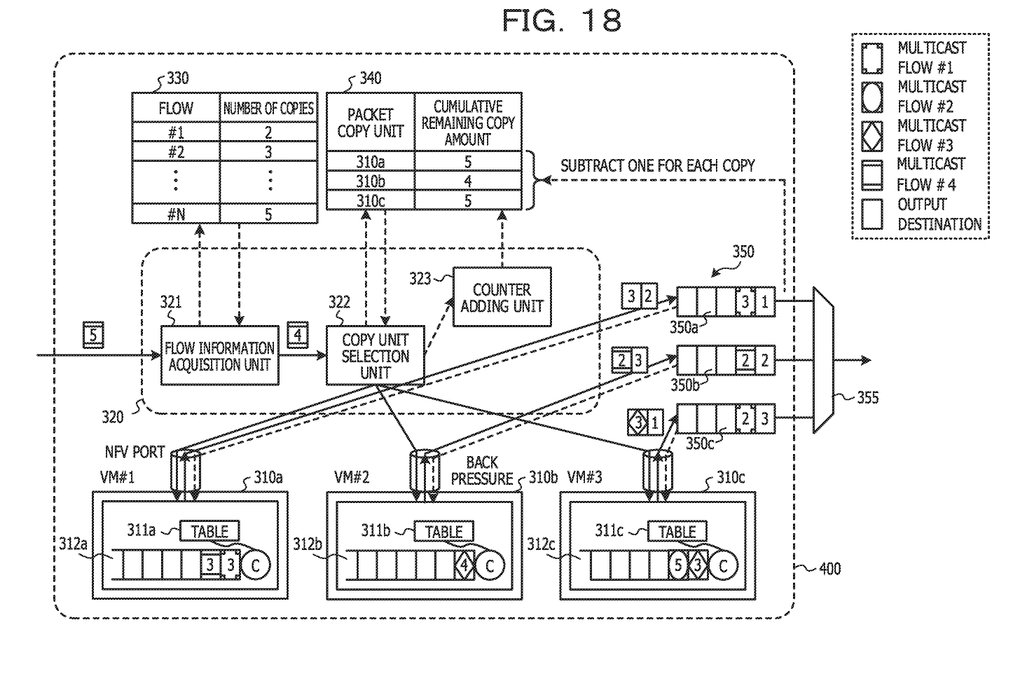

Embodiment 4 includes a speed adjustment buffer 350 and a combining unit 355 for each external copy unit 310 in addition to the configuration of Embodiment 3. FIG. 18 illustrates a copy functional block 400 according to Embodiment 4. In addition, the same configuration requirements as in Embodiment 3 are denoted by the same reference numerals.

The speed adjustment buffer 350 has a speed adjustment and a back pressure, by delaying the copy packet, and it is possible to stop temporarily duplicate by applying a back pressure to the copy unit. Hereinafter, the speed adjustment buffer 350 is described as the buffer unit 350. Further, the cumulative remaining copy amount is subtracted, when a packet is output from the buffer unit 350. The packet that has been adjusted in the buffer unit 350 is read out according to the conditions of the combining unit 355.

The combining unit 355 reads the output from each buffer unit 350 by the conditional Fair Queuing. The conditions will be described later.

If the copy of a packet is performed by an external server, or the like, the processing performances and the like of respective servers (CPU performance, and the like) are different, or an interrupt process and the like occurs in the CPU, the processing performance is likely to be uneven and unstable in each server, even if a packet is distributed to the copy unit 310 with a minimum substantial queue, the packet is not output in an expected order, and thus consideration has to be given to the possibility of order reversal, such that the speed adjustment of the buffer unit 350 is used.

In addition, since it is difficult for the load distribution unit 320 in the former stage to predict a performance difference based on a destabilizing factor of the copy unit 310, the copy unit 310 in the latter stage treating reactively the performance difference is considered better, but distribution may be performed by considering it if the former stage is able to consider it.

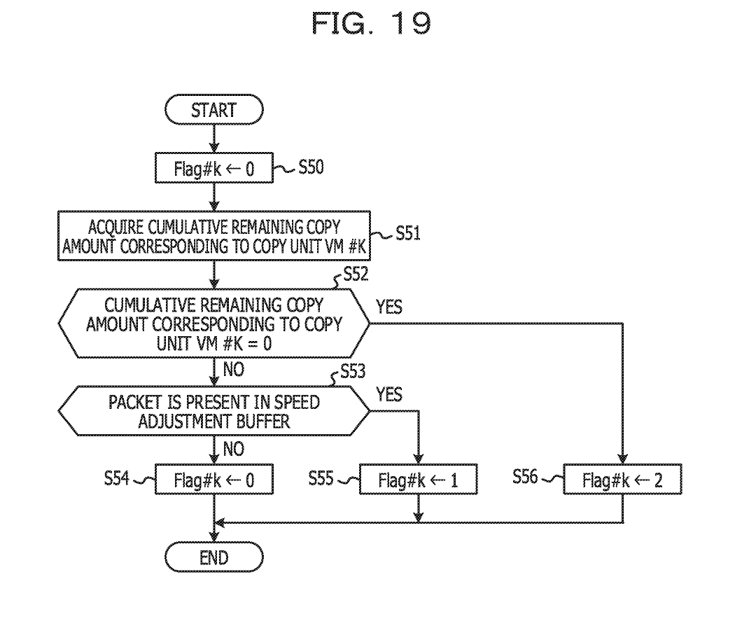

FIG. 19 illustrates an example of a flowchart of conditional Fair Queuing of the combining unit 355, which is a mechanism to dissolve the unstable factors due to the performance difference of the copy unit 310. The flowchart of FIG. 19 is performed on each copy unit 310. In addition, k in the flow chart indicates the number of copy unit 310 (VM #k).

0 is stored in Flag #k corresponding to VM #k (S50). The cumulative remaining copy amount corresponding to the copy unit 310 (VM #k) is acquired (S51). It is examined whether or not the cumulative remaining copy amount corresponding to copy unit VM #k=0 (S52).

When the cumulative remaining copy amount is 0 (S52: Yes), 2 is stored in Flag #k (S56) and the process is ended. When the cumulative remaining copy amount is not 0 (S52: No), it is examined the presence or absence of a packet of the buffer unit 350 (S53).

When there is a packet in the buffer unit 355 (S53: Yes), 1 is stored in Flag #k (S56) and the process is ended. When there is not a packet in the buffer unit 355 (S53: No), 0 is stored in Flag #k (S54) and the process is ended.

When 2 is stored all in Flag #k of each copy unit 310 (VN #k), since all Q skip, reading is not possible (there is no packet to be read). If 0 is stored even in one of all Flags #k, the reading of the combining unit 355 is temporarily stopped. However, when 2 is stored in all remaining copy units 310 (the copy unit 310 that does not indicate that Flag # k is 0), without being limited thereto, since all Q skip, reading is not possible (there is no packet to be read). In other case (1 is stored in any one among all Flags # k, and 2 is not stored in any), the packet is reading in Fair Queuing. Since the reading is performed based on such conditions, the combining unit 355 combines the signals after waiting for the output from each copy unit 310 so as to avoid the order reversal.

In addition, when temporarily stopping the reading in the combining unit 355, a buffer unit 350 other than the buffer unit 350 may issue an instruction of backpressure in order to temporarily stop the copy of the copy unit 310 associated with the buffer unit 350 other than the buffer unit 350.

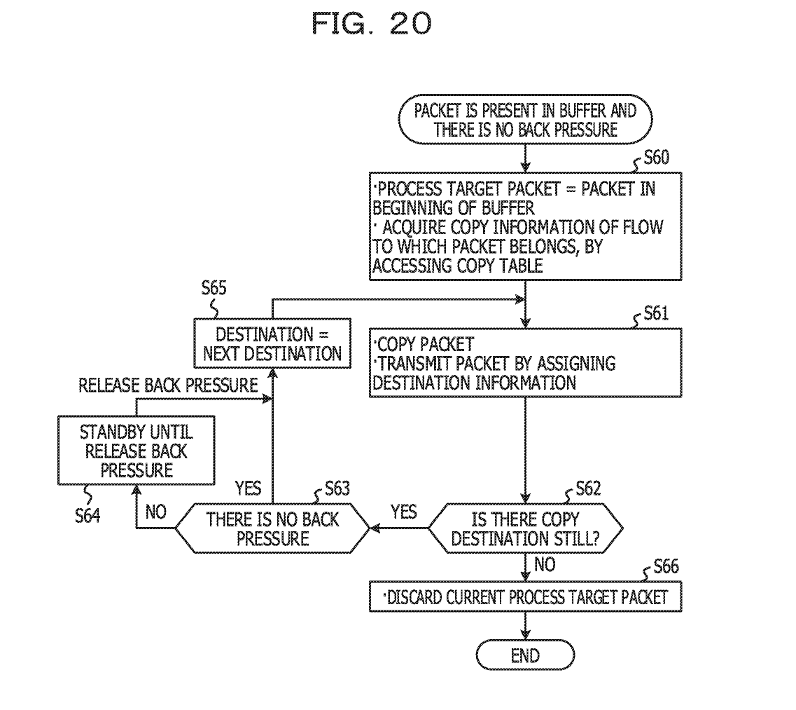

FIG. 20 illustrates an example of a flowchart of a copy unit 310 according to Embodiment 4. When there is a packet in the storage unit 312, and there is no back-pressure from the buffer unit 350, a copy process is started.

If there is a packet in a buffer in the copy unit 310, the number of copies of the flow to which a process target packet (a top packet of the storage unit 312) belongs is acquired by accessing the copy table 311 (S60).

The packet is copied, and destination information is assigned to the copy packets and is transmitted (S61).

It is checked whether or not the copy destination of the packet remains (S62). When the copy destination does not remains (S62: No), the current processing target packet is discarded (S66). When it remains (S62: Yes), a back pressure value is checked from the buffer unit 350 (S63).

If there is a back pressure (S63: No), it is on standby until the back pressure is released (S64). When the backpressure is released or there is no back pressure (S63: Yes), a destination is changed to the next destination (S65), and the process moves to S61.

In addition, the load distribution unit 320 grants and transmits the destination at the time of the distribution, in a substantially the same manner as Embodiment 1.

Through the configuration of Embodiment 4, even if the processing capacities of the external copy units 310 are different, the distribution of the copy process of a packet is possible while protecting the order in the same flow.

### Embodiment 5

In Embodiment 5, information on a valid flag is added to the cumulative remaining copy management table 340 for supporting a newly added copy unit 310.

There is a NFV as an example using an external copy unit 310. As characteristics of the NFV, the addition/deletion of the functions may flexibly be performed depending on the addition of a copy unit. For example, although in current situation, a distribution process is performed by three copy units 310 such as VM #1, 2, and 3, if the load becomes higher, a VM #4 is added, and to the contrary, if the load becomes lower, a process such as deletion of VM #3 is easily performed.

When the copy unit 310 is deleted, the distribution of a packet to the copy unit 310 is no longer performed, and a particular problem does not occur. However, there is a possibility that the order reversal occurs when a copy unit is added.

Therefore, there is provided a mechanism in which a valid flag indicating the availability of the distribution is added to the cumulative remaining copy management table 340, only the copy unit 310 with the valid flag of 1 (distribution is possible) is subject to the packet distribution, the initial value of the valid flag of a copy unit 310 that is newly added is set to 0 (distribution is not possible), and when the cumulative remaining copy amount is equal to or greater than the maximum value of the cumulative remaining copy amount of existing copy unit, the valid flag is set to 1.

Thus, when the newly added copy unit is in a valid state, the valid flag is 1, and the copy unit becomes a distribution target. For example, when a packet no longer arrives temporarily, and all of the cumulative remaining copy amounts become 0, a new cumulative remaining copy amount (=0) is the maximum value (=0) of the cumulative remaining copy amount of the existing copy unit 310 or more, such that the valid flag becomes 1, and the copy unit becomes a distribution target.

### Embodiment 6

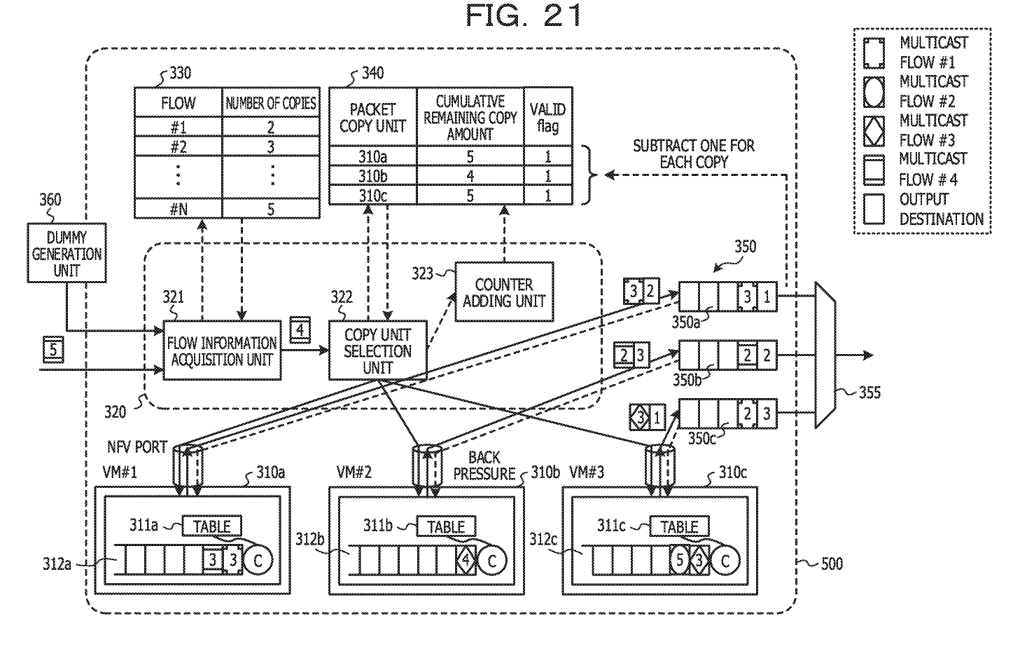

Embodiment 6 includes a dummy generation unit 360 in addition to Embodiment 3. FIG. 21 illustrates a configuration of a copy functional block 500 according to Embodiment 6. Further, FIG. 21 illustrates a configuration obtained by adding a dummy generation unit 360 for using the valid flag used in Embodiment 5 to Embodiment 4, but Embodiment 6 is not limited thereto. In addition, the same configuration requirements as in Embodiment 4 are denoted by the same reference numerals.

The dummy generation unit 360 generates a dummy packet.

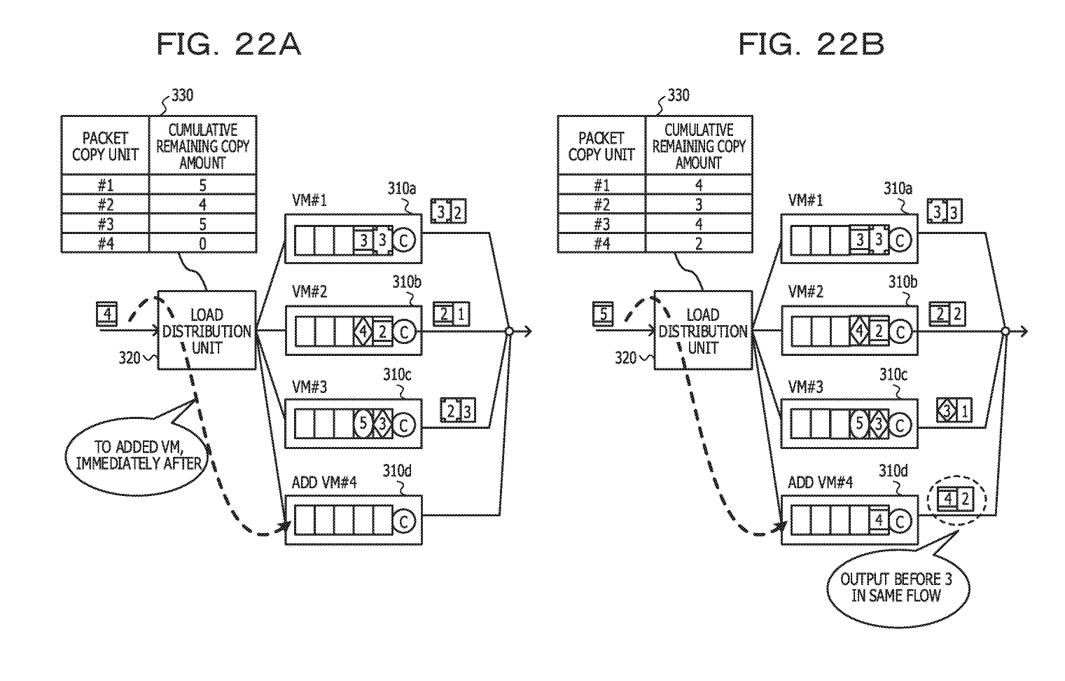

For example, as illustrated in FIG. 22A, when a copy unit 310d (VM #4) is added while copy units 310a to 310c (VM #1, 2, and 3) are operating, since the copy unit 310d (VM #4) does not have a packet, the cumulative remaining copy amount=0, and the copy unit 310d (VM #4) is likely to be a candidate for the distribution destination. However, since this is not a minimum value selection due to valid comparison, order reversal may occur as illustrated in FIG. 22B. In other words, due to a reason of addition during the operation, while the cumulative remaining copy amount is small, valid comparison is not possible.

However, if the cumulative remaining copy amount becomes a maximum by some measures, it is not selected even against the normal selection logic. Once it becomes in such a state, the cumulative remaining copy amount of a newly added copy unit 310d becomes significantly smaller than other existing copy units 310a to 310c, and it refers to a valid state where the influence of participation in the middle is avoided.

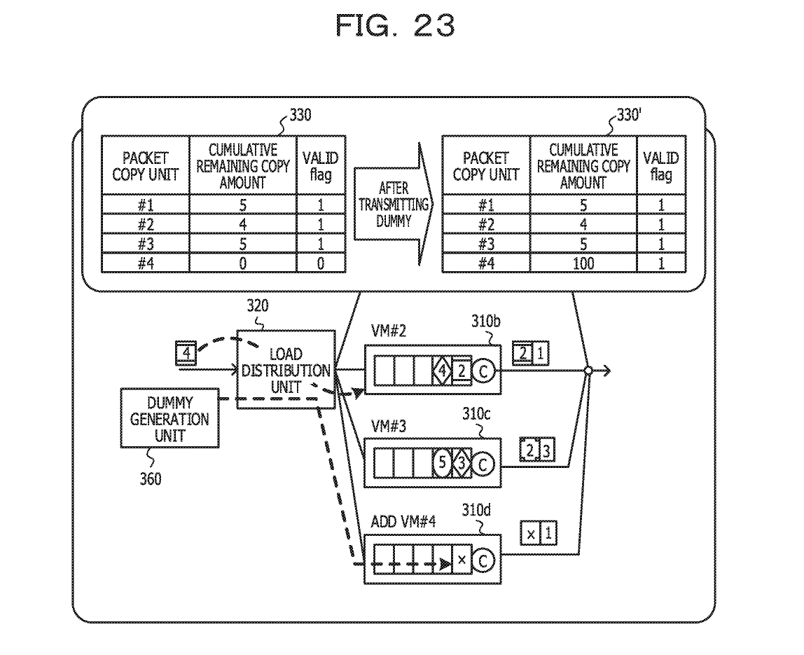

Thus, the packet relay device 1 includes a dummy generation unit 360 therein, and inputs a dummy packet to the copy unit 310d, and increases the cumulative remaining copy amount. FIG. 23 illustrates a state in which a dummy packet is generated and is sent to the copy unit 310d (VM #4). The cumulative remaining copy amount management table 330 in FIG. 23 becomes a cumulative remaining copy amount management table 330′ after transmission of the dummy packet. In FIG. 23, as an example, 100 dummy packets are generated and sent to the copy unit 310d, but it is preferred that the cumulative remaining copy amount of the copy unit 310d is equal to or greater than the maximum value of the cumulative remaining copy amounts of the existing copy units 310a to 310c (in FIG. 23, seven or more).

At this time, the valid flag is 1 after the completion of the dummy packet distribution using the valid flag used in Embodiment 5.

Through the configuration of Embodiment 6, it is possible to correctly secure the relationship with the existing copy units 310a to 310c for the newly added copy unit 310d, and distribution of a packet becomes possible.

Further, in the case of managing the cumulative remaining copy amount by the number of bytes, the number of corresponding bytes may be summed and generated by the dummy generation unit 360 and copied.

### Embodiment 7

Embodiment 7 causes a newly added copy unit 310d to perform virtual-reading of the maximum value or more of the cumulative remaining copy amount of the existing copy units 310a to 310c. By using the method of Embodiment 7, since the cumulative remaining copy amount is managed by virtual-reading without using the dummy generation unit 360 used in Embodiment 6, it is possible to accurately maintain the relationship with the existing copy units, and distribution of packet becomes possible.

When the cumulative remaining copy amount is managed by the number of bytes, the number of corresponding bytes may be arranged and be virtually copied.

### Embodiment 8

Embodiment 8 is a method in which the number of cumulative remaining copies of each flow is manage, and the flow with the number of cumulative remaining copies of 0 is distributed to the copy unit 310d, and thus the same number of copies as the existing copy units 310a to 310c are obtained. In this case, the distributed flows may be stored in the copy unit 310d, and the flows that are distributed to the copy unit 310d may be compared and distributed by all of the copy units 310.

Through the configuration of Embodiment 8, a packet can be more efficiently copied by the newly added copy unit 310, as compared to the virtual-reading or the dummy packet.

However, the drawings used in Embodiment 3 to Embodiment 8 have been illustrated, with the copy amount as the number of copies, in the case of the fixed length. Without being limited thereto, the copy amount described in Embodiment 2 may be managed by the number of bytes, and distribution may be performed.

According to the packet relay device described above, it is possible to realize a packet relay device and a packet copy function distribution method of a packet relay device, in which when a copy function is distributed and processed, the load distribution is made as equal as possible, while protecting the order in the same flow.

Next, with respect to embodiments including the examples described above, the following claims are further disclosed. It is not intended that the embodiment be limited to the following claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention.

Although the embodiments of the present invention have been described in detail, it should be understood that the various changes, substitutions, and alterations could be made hereto without departing from the spirit and scope of the invention.

What is claimed is:

1. A packet relay device comprising:
a plurality of first circuits configured to duplicate and transmit a packet;
a memory configured to store the packet correspond to one of the plurality of first circuit; and
a second circuit configured to select one of the plurality of first circuits, using cumulative remaining copy amount correspond to each of the plurality of first circuits that are calculated based on the packet accumulation in the memory.

2. The packet relay device according to claim 1,
wherein the cumulative remaining copy amount corresponding to each of the plurality of first circuits is updated by performing an addition process on the cumulative remaining copy amount corresponding to the memory to which the packet is transmitted, among correspond to the plurality of first circuit, based on the number of copies of the packet, and performing a subtraction process on the cumulative remaining copy amount corresponding to a first circuits which transmitted a copy packet, among the plurality of first circuits, based on the copy packet.

3. The packet relay device according to claim 1,
wherein each of the plurality of first circuits assigns in-device destination information, based on information on the packet stored in the memory associated with each first circuit, reads the packet from the memory, and duplicates a copy packet.

4. The packet relay device according to claim 1,
wherein the packet is a fixed-length packet, and
the cumulative remaining copy amount is the number of cumulative remaining copies.

5. The packet relay device according to claim 1,
wherein the cumulative remaining copy amount is the number of cumulative remaining copy bytes.

6. The packet relay device according to claim 4,
wherein the second circuit select one of the first circuits having a minimum cumulative remaining copy amount, among the plurality of first circuits.

7. The packet relay device according to claim 1,
wherein the memory is stored the number of copies for each flow of the packet,
the memory further includes most recent information indicating a destination of a most recent packet for each flow, and time information indicating when transmission of the most recent packet of the flow is completed, and
the second circuit performs distribution, based on the most recent information, the time information, and the cumulative remaining copy amount.

8. The packet relay device according to claim 9,
wherein the memory is stored a flag indicating the presence or absence of the packet in the plurality of first circuits for each flow of the packet, and when the flag indicates invalid, the packet is distributed to the plurality of first circuits, based on the cumulative remaining copy amount.

9. The packet relay device according to claim 1, further comprising:
a third circuit configured to divide the packet into a packet body and a memory address on an input side of the second circuit, and form an information packet by adding information indispensable for copying to the memory address;
a packet memory configured to store the packet body; and
a fourth circuit configured to read the stored packet body, based on the information packet that is copied by any one of the plurality of first circuits.

10. The packet relay device according to claim 1,
wherein the plurality of first circuits perform duplicating on the packet of an identical flow so as to assign output destination information of a copy packet in an identical order.

11. A packet relay device comprising:
a memory configured to store a plurality of destination information correspond to a cumulative remaining copy amount; and
a first circuit configured to assign any one of the plurality of destination information to a packet, based on the cumulative remaining copy amount, and transmit the packet,
wherein the cumulative remaining copy amount is updated by adding the cumulative remaining copy amount of the destination information based on the number of copies of the packet, the cumulative remaining copy amount being assigned according to transmission of the packet from the first circuit, and subtracting from a copy packet the cumulative remaining copy amount of destination information corresponding to information on a transmission source of the received the copy packet.

12. The packet relay device according to claim 11,
wherein the memory further includes a flag indicating availability of distribution for each of the plurality of destination information, and
the first circuit assigns any one of the plurality of destination information for which the flag indicates possibility of distribution.

13. The packet relay device according to claim 12, further comprising:
a dummy generator configured to generate a dummy packet,
wherein the dummy generator transmits the dummy packet until the cumulative remaining copy amount of newly added destination information is larger than a maximum cumulative remaining copy amount of the plurality of destination information, among the plurality of destination information, and
the flag of the newly added destination information indicates impossibility of distribution at a time of addition, and if the cumulative remaining copy amount of the newly added destination information is equal to or greater than the maximum cumulative remaining copy amount of the existing destination information, among the cumulative remaining copy amounts, the flag changes into “possibility of distribution”.

14. The packet relay device according to claim 12,
wherein the flag of the newly added destination information indicates impossibility of distribution at a time of new addition, and if the cumulative remaining copy amount of the newly added destination information is equal to or greater than a maximum value of the cumulative remaining copy amount of the existing destination information, among the cumulative remaining copy amounts, the flag changes into “possibility of distribution”, and
the first circuit enables distribution only of the packet of an identical flow to a newly added destination information that does not transmit the packet of the identical flow to existing destination information or receives all of the copy packets by transmitting the packet of the identical flow to the existing destination information.

15. The packet relay device according to claim 11, further comprising:
a plurality of buffers configured to adjust a speed of the copy packet after receiving the copy packet, each of the plurality of buffers being associated with each of the plurality of destination information.

16. The packet relay device according to claim 15,
wherein if the copy packets stored in the buffers exceed a threshold that the plurality of buffers have, the buffers transmits information by assigning corresponding destination information, in order to temporarily stop transmission of the copy packet.

17. The packet relay device according to claim 16, further comprising:
a second circuit configured to combine the copy packets,
wherein the second circuit combines the copy packets, based on the cumulative remaining copy amount and a amount of the copy packet in the plurality of buffers.

18. The packet relay device according to claim 11,
wherein a memory store the number of copies for each flow of the packet, and
the first circuit acquires the number of copies of the packet from the memory.

19. A copy distribution method of a packet relay device, comprising:
selecting one of a plurality of copy function that duplicate a packet, using a cumulative remaining copy amount corresponding to each of a plurality of the plurality of copy function that are calculated based on number of duplicated packet, and
transmitting the packet to the selected the copy function.
